(19) United States
(12) Patent Application Publication
(10) Pub. No.: US 2010/0047631 A1
(43) Pub. Date: Feb. 25, 2010

(54) MEMBRANE ELECTRODE ASSEMBLY HAVING PROTECTIVE LAYER AND METHOD FOR MITIGATING MEMBRANE DECAY

(75) Inventors: Thomas H. Madden, Glastonbury, CT (US); Sergei F. Burlatsky, West Hartford, CT (US); Carl A. Reiser, Stonington, CT (US)

Correspondence Address: BACHMAN & LAPOINTE, P.C., 900 CHAPEL STREET, SUITE 1201, NEW HAVEN, CT, 06510, US

(73) Assignee: UTC POWER CORPORATION, South Windsor, CT (US)

(21) Appl. No.: 12/444,622

(22) PCT Filed: Oct. 24, 2006
(86) PCT No.: PCT/US06/41598

§ 371 Date: Apr. 7, 2009

(51) Int. Cl. H01M 4/92; H01M 8/10

(52) U.S. Cl. 429/13; 429/30; 429/40

(57) ABSTRACT

A membrane electrode assembly includes an anode; a cathode; a membrane disposed between the anode and the cathode; and a protective layer positioned between the membrane and the cathode, the protective layer having a first side and a second side and being adapted to restrict migration of oxygen at the first side and to restrict the migration of hydrogen at the second side and thereby maintain a plane of potential change between the anode and the cathode within the protective layer.

### BACKGROUND OF THE DISCLOSURE

The disclosure relates to fuel cells and, more particularly, to PEM fuel cells and reduction in degradation of the membrane of same.

In a PEM fuel cell, various mechanisms can cause peroxide to form or exist in the vicinity of the membrane. This peroxide can dissociate into highly reactive free radicals. These free radicals can rapidly degrade the membrane.

It is desired to achieve 40,000-70,000 hour and 5,000-10,000 hour lifetimes for stationary and transportation PEM fuel cells, respectively. Free radical degradation of the ionomer seriously interferes with efforts to reach these goals.

It is therefore the primary object of the present disclosure to provide a membrane electrode assembly which addresses these issues.

It is a further object of the disclosure to provide a method for operating a fuel cell which further addresses these issues.

Other objects and advantages appear herein.

### SUMMARY OF THE DISCLOSURE

In accordance with the present disclosure, the foregoing objects and advantages have been attained.

According to the disclosure, a membrane electrode assembly is provided which comprises an anode; a cathode; a membrane between the anode and the cathode; and a protective layer between the membrane and the cathode, the protective layer being adapted to block oxygen at one side and hydrogen at the other side and thereby maintain a plane of potential change between the anode and the cathode within the protective layer.

In further accordance with the disclosure, a method is provided for mitigating decay of a membrane electrode assembly, which method comprises selectively operating a membrane electrode assembly in an on-load condition and an off-load condition, the membrane electrode assembly having an anode, a cathode, a membrane between the anode and the cathode, and a protective layer between the membrane and the cathode, wherein a plane of potential change between the anode and the cathode falls within the protective layer in both the on-load condition and the off-load condition.

### BRIEF DESCRIPTION OF THE DRAWINGS

A detailed description of preferred embodiments of the present disclosure follows, with reference to the attached drawings, wherein:

FIG. 1 schematically illustrates a membrane electrode assembly including a protective layer in accordance with the present disclosure; and

FIG. 2 illustrates potential through a portion of the assembly due to the protective layer of the present disclosure.

### DETAILED DESCRIPTION

The disclosure relates to fuel cells and, more particularly, to polymer electrolyte membrane (PEM) fuel cells, and to mitigating decay or degradation of such fuel cells due to on-load and off-load operation and cycling between same.

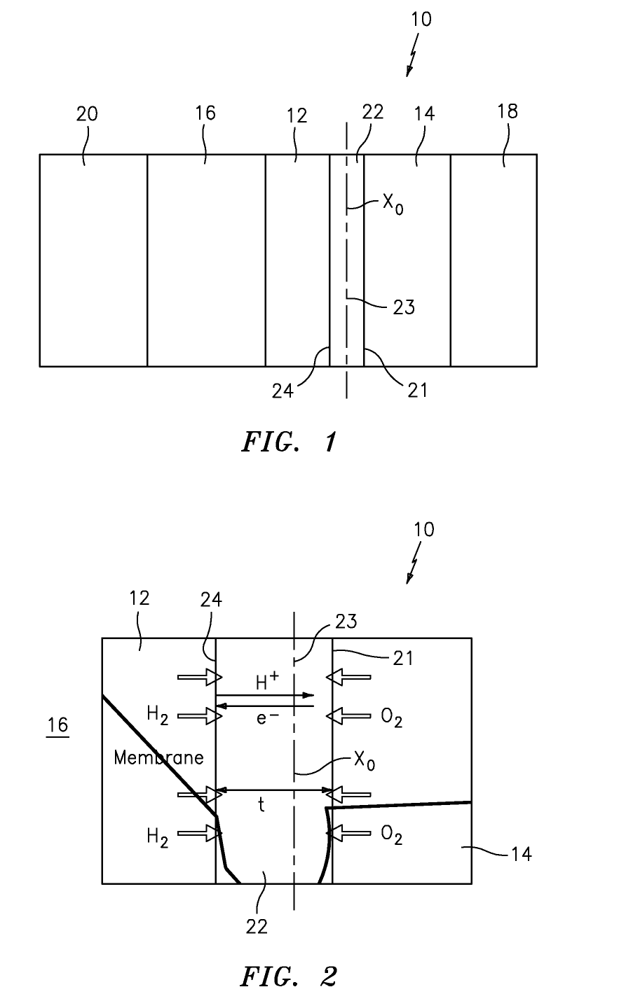

FIG. 1 schematically illustrates a membrane electrode assembly (MEA) 10 in accordance with the disclosure. As shown, assembly 10 includes a membrane 12, a cathode 14, an anode 16, and gas diffusion layers 18, 20. According to the disclosure, a protective layer 22 is also provided, preferably between membrane 12 and cathode 14. Cathode 14 and anode 16 are positioned to either side of membrane 12 as shown, with gas diffusion layers 18, 20 positioned to either side of the electrodes (cathode 14 and anode 16).

As is well known to a person skilled in the art, membrane electrode assembly 10 is operated by feeding oxygen in some form through gas diffusion layer 18 to cathode 14 and by feeding hydrogen in some form through gas diffusion layer 20 to anode 16. These reactants support generation of an ionic current across membrane 12 as desired.

Cathode 14 is a porous layer containing a suitable cathode catalyst and typically having a porosity of at least about 30%. Anode 16 is similarly a porous layer containing suitable anode catalyst, and also typically has a porosity of at least about 30%.

During operation of assembly 10, catalyst materials which are typically present within the electrodes, that is, cathode 14 and/or anode 16, can dissolve and then precipitate elsewhere in the assembly.

It has been found, as shown in FIG. 2, that during operation of the MEA, there is a plane of sharp potential change between the electrodes, and this plane of potential change is referred to as Xo 23. At Xo 23, reaction potential abruptly shifts from a low value to a high value. The position of Xo 23 depends heavily on the oxidant and reductant gas concentrations at locations on either side of Xo 23. If electrically isolated catalyst particles are present at Xo 23, this is a very likely position for formation of peroxide and/or generation of radicals which can have a deleterious effect upon membrane 12 and other ionomer present within assembly 10.

It has further been found that dissolved catalyst metal tends to precipitate or deposit at Xo 23, and that this deposited metal can increase the chance of formation of peroxide and/or radicals. Peroxide has been found to be directly responsible for degradation of membrane 12, because peroxide under certain conditions can break down to form radicals which react with the membrane and then carry portions of the membrane out of assembly 10 through exhaust from same. Also, radicals (e.g. hydroxyl or peroxyl) may form directly on such catalyst precipitates from the reaction of crossover gases and/or peroxide, which proceed to degrade the membrane.

During electrical load cycling of assembly 10, the concentration of reactants varies and the position of Xo 23 can move. When this happens, there is increased tendency toward dissolution of catalyst metal from the previous Xo 23 location to the new Xo 23 location. This is because after a certain amount of time of operation, sufficient metal deposits at Xo 23 that there is less driving force for dissolution. However, when Xo 23 moves, additional dissolution of catalyst can take place from both the electrodes and from catalyst particles already deposited in the membrane. Such a process can be especially damaging to the membrane due to the high specific area of catalyst surface that results. As set forth above, in accordance with the disclosure, protective layer 22 is utilized to keep Xo 23, the plane of potential change, at a particular position during normal, or on-load operation, and further steps are taken during off-load operation to further maintain Xo 23 in a desired position.

According to the disclosure, several embodiments of protective layer 22 are provided, each of which serves to restrict migration of hydrogen and oxygen. Oxygen is restricted at a side of layer 22 which faces the cathode, and hydrogen is restricted at the other side of layer 22. This results in Xo 23 remaining within layer 22 as desired.

The disclosed embodiments include catalyzed layers which chemically scavenge oxygen and hydrogen, for example forming water.

In one embodiment, protective layer 22 is advantageously a layer of ionomer material preferably containing a catalyst, the catalyst preferably in particulate form. The protective layer 22 preferably has a porosity of less than about 10% by volume (most preferably non-porous), contains between about 50% and about 80% vol ionomer, and between about 10% and about 50% vol catalyst. Electrical connectivity between the catalyst particles is preferably between about 35% and about 95%. These catalyst particles in the protective layer 22 are substantially electrically connected to the cathode. They may alternatively or even preferably be electrically connected by a high surface area support material.

During normal operation of assembly 10, protective layer 22 is substantially electrically connected to cathode 14 and serves to scavenge any oxygen which would otherwise cross over into membrane 12 and also scavenges hydrogen, which has crossed through membrane 12. Because of this, Xo 23 is forced to reside within protective layer 22 during on-load operation. Protective layer 22 may also serve to decompose any peroxide formed, for example at cathode 14.

During off-load operation, no scavenging of crossover oxygen takes place in protective layer 22 since no current flows in the cell. In this situation, an air starvation protocol is implemented, whereby the oxygen normally fed to gas diffusion layer 18 to cathode 14 is instead stopped or redirected away from cathode 14, for example by being vented to ambient conditions instead. While protective layer 22 under off-load conditions has reduced effectiveness at scavenging oxygen, the air or oxygen starvation protocol provides the same effect, which tends to keep Xo 23 within protective layer 22 during off-load conditions as well. Such a protocol also limits the high potential that the cathode would otherwise experience by allowing crossover hydrogen to reduce the cathode potential.

Different types of ionomer and catalyst material can be used in this embodiment. As will be further discussed, the protective layer in this embodiment serves to scavenge crossover gasses by having a high gas reaction rate and a low gas diffusion rate. The protective layer further serves to maximize selectivity to benign products, preferably water, from such crossover gasses and may serve to decompose peroxide. In addition, since the protective layer is intended, according to the disclosure, to contain Xo 23, the protective layer structure advantageously discourages the loss of catalyst from the electrodes as discussed below.

The catalyst in protective layer 22 is preferably largely electrically connected, and protective layer 22 therefore serves as a sink for deposition of dissolved catalyst metal, and the dissolution driving force is reduced or eliminated. Thus, keeping Xo 23 within protective layer 22 minimizes or eliminates the driving force under both on and off-load operating conditions.

In accordance with this embodiment, the protective layer 22 comprises a catalyst, for example, carbon supported platinum or platinum alloy particles, the pores of which are filled with polymer electrolyte, or ionomer material. When platinum alloys are used, the catalyst particles can advantageously be binary and/or ternary alloys, and can be supported, for example on carbon, or non-supported.

One suitable platinum alloy has the formula PtₓY₁₋ₓ, wherein Y is selected from the group consisting of Co, Ni, Ir, Rh, V, Cu, Fe, Cr, Pd, Ti, W, Al, Ag, Cu and combinations thereof, and x is between 0.1 and 0.9.

According to a further embodiment of the disclosure, the platinum alloy can have the formula PtₓM_{z}Y_{1-x-z}, wherein: M is selected from the group consisting of Ir, Rh, Co, Ni and combinations thereof; Y is selected from the group consisting of Co, Ni, V, Cu, Fe, Cr, Pd, Ti, W, Al, Ag, Cu, Au and combinations thereof; and x+z is between 0.1 and 0.9.

According to a still further embodiment, the platinum alloy has the formula PtₓZ₁₋ₓ, wherein Z is selected from the group consisting of Ru, Mo, and combinations thereof, and wherein x is between 0.1 and 0.9.

Other suitable catalysts, including other metal alloy catalysts, can be utilized. Alternatives may be apparent to a person of skill in the art. While the foregoing embodiments represent preferred configurations, such alternatives are considered to be well within the broad scope of the present disclosure.

At the relatively high potential which will be present in protective layer 22, the four electron reduction of oxygen is predominately achieved so as to produce water and not produce peroxide. Thus, oxygen is scavenged by protective layer 22 at high potential as desired.

Protective layer 22 serves to consume such oxygen at high potential, most actively at the interface 21 between protective layer 22 and cathode 14. Protective layer 22 further serves to consume hydrogen at the interface 24 between membrane 12 and protective layer 22. Further, protective layer 22 also provides for benign decomposition of peroxide at interface 24 and throughout the thickness of the layer 22 if peroxide is generated in cathode 14 and/or at interface 24 and throughout the thickness of layer 22 if peroxide is generated in anode 16. These functions advantageously reduce a significant contributor toward cell degradation.

In order to provide desirable results, protective layer 22 is advantageously electrically connected to cathode 14 through an electrically conducting phase, for example such as carbon support material, so as to ensure high potential and, therefore, consumption of crossover oxygen to produce water. Unsupported catalyst particles may also be electrically connected to the cathode through an interconnected network.

Protective layer 22 further preferably has substantially no porosity and a relatively high oxygen reduction rate which is preferably substantially the same as, or greater than, the oxygen reduction rate of the cathode. This will result in a maximized ratio of oxygen reduction rate to oxygen diffusion rate, and thereby will minimize oxygen escape from the cathode.

In this regard, protective layer 22 advantageously has a porosity of less than about 10%, and is preferably substantially non-porous (substantially 0% porosity). Oxygen reduction rate per unit platinum surface area for protective layer 22 is also advantageously approximately the same as the cathode because of electrical connectivity to the cathode.

Any porosity of protective layer 22 should advantageously be flooded during operation, for example with water, so as to reduce the oxygen diffusion rate through the protective layer 22. A layer 22 having porosity which is flooded with water during normal operation is considered to be non-porous as used herein since the water-filled porosity is substantially less porous to reactant gasses.

Provision of a protective layer 22 having these properties advantageously results in efficient oxygen consumption at interface 21 and throughout layer 22 and, therefore, proper conditions for keeping Xo 23 within layer 22 during the on-load operating conditions.

As set forth above, providing protective layer 22 between cathode 14 and membrane 12 advantageously serves to define Xo 23 within protective layer 22 as desired, thereby allowing for reduced chance of catalyst driven generation of peroxide and catalyst driven formation of radicals, and also minimizing movement of Xo 23 such that a sink of catalyst material can be initially provided in protective layer, or initially deposited in protective layer 22 during early operation, to thereby reduce or eliminate the driving force for catalyst dissolution during on-load operation.

Protective layer 22 can be provided using various ionomer materials as discussed above, and advantageously serves to force Xo 23 to stay within protective layer 22 as desired.

In further accordance with the disclosure, protective layer 22 can include a hydrocarbon (non-fluorinated) ionomer, or a per-fluorinated ionomer (such as Nafion), or a combination, for example, by substantially homogeneously blending hydrocarbon in liquid ionomer or particulate form into the per-fluorinated ionomer-based material.

During off-load operation, oxidant is re-directed away from cathode 14, and this serves to maintain oxygen depletion in the vicinity of protective layer 22 and thereby to keep Xo 23 within protective layer 22 as desired.

It should be appreciated that the present disclosure, drawn to reduction of degradation due to on-load and off-load operation, and cycling between them, advantageously accomplishes this purpose. Furthermore, it should be appreciated that the disclosure is useful in connection with a wide variety of different types of ionomer in the protective layer, all within the broad scope of the present disclosure.

While the present disclosure has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

What is claimed:

1. A membrane electrode assembly, comprising:
an anode;
a cathode;
a membrane between the anode and the cathode; and
a protective layer between the membrane and the cathode, the protective layer having first and second opposed sides and being adapted to restrict oxygen at the first side and to restrict hydrogen at the second side and thereby maintain a plane of potential change between the anode and the cathode within the protective layer.

2. The assembly of claim 1, wherein the protective layer comprises a layer of ionomer material containing catalyst selected to scavenge at least one of hydrogen and oxygen.

3. The assembly of claim 1, wherein the protective layer has an oxygen reduction rate which is substantially the same or greater than the cathode.

4. The assembly of claim 2, wherein the protective layer comprises catalyst particles selected from the group consisting of particles of carbon, particles of platinum, particles of platinum alloy and combinations thereof.

5. The assembly of claim 4, wherein the catalyst particles comprise particles of platinum or particles of platinum alloy, and wherein the catalyst particles are supported on carbon.

6. The assembly of claim 4, wherein the particles comprise platinum alloy selected from the group consisting of binary alloys, ternary alloys and combinations thereof.

7. The assembly of claim 6, wherein the platinum alloy has the formula PtₓY₁₋ₓ, wherein Y is selected from the group consisting of Co, Ni, Ir, Rh, V, Cu, Fe, Cr, Pd, Ti, W, Al, Ag, Cu and combinations thereof, and x is between 0.1 and 0.9.

8. The assembly of claim 6, wherein the platinum alloy has the formula PtₓM_{z}Y_{1-x-z}, and wherein:
M is selected from the group consisting of Ir, Rh, Co, Ni and combinations thereof;
Y is selected from the group consisting of Co, Ni, V, Cu, Fe, Cr, Pd, Ti, W, Al, Ag, Cu, Au and combinations thereof; and
x+z is between 0.1 and 0.9.

9. The assembly of claim 6, wherein the platinum alloy has the formula PtₓZ₁₋ₓ, wherein Z is selected from the group consisting of Ru, Mo, and combinations thereof, and wherein x is between 0.1 and 0.9.

10. The assembly of claim 2, wherein the protective layer is electrically connected to the cathode.

11. The assembly of claim 4, wherein the catalyst particles in the protective layer are substantially electrically connected to the cathode.

12. The assembly of claim 11, wherein the catalyst particles are electrically connected to the cathode via a high surface area support material.

13. The assembly of claim 1, wherein the protective layer has a porosity of less than 10%.

14. The assembly of claim 13, wherein the protective layer is substantially non-porous.

15. The assembly of claim 1, wherein the protective layer is an electrically connected and ionically conductive structure having a porosity of between 0% and 10%, wherein the catalyst is present in an amount between 10% and 50% vol based upon volume of the layer, and ion-exchange material is present in an amount between 50% and 80% vol based upon volume of the layer.

16. A method for mitigating decay of a membrane electrode assembly, comprising selectively operating a membrane electrode assembly in an on-load condition and an off-load condition, the membrane electrode assembly having an anode, a cathode, a membrane between the anode and the cathode, and a protective layer between the membrane and the cathode, wherein a plane of potential change between the anode and the cathode falls within the protective layer in both the on-load condition and the off-load condition.

17. The method of claim 16, wherein operation in the off-load condition comprises stopping flow of oxidant to the cathode or re-directing the oxidant away from the cathode.

18. The method of claim 16, wherein the protective layer comprises a layer of ionomer material containing catalyst selected to scavenge at least one of hydrogen and oxygen.

19. The method of claim 16, wherein the protective layer has an oxygen reduction rate which is substantially the same or greater than the cathode.

20. The method of claim 16, wherein the protective layer comprises catalyst particles selected from the group consisting of particles of carbon, particles of platinum, particles of platinum alloy and combinations thereof.

21. The method of claim 20, wherein the catalyst particles comprise particles of platinum or particles of platinum alloy, and wherein the catalyst particles are supported on carbon.

22. The method of claim 20, wherein the particles comprise platinum alloy selected from the group consisting of binary alloys, ternary alloys and combinations thereof.

23. The method of claim 22, wherein the platinum alloy has the formula PtₓY₁₋ₓ, wherein Y is selected from the group consisting of Co, Ni, Ir, Rh, V, Cu, Fe, Cr, Pd, Ti, W, Al, Ag, Cu and combinations thereof, and x is between 0.1 and 0.9.

24. The method of claim 22, wherein the platinum alloy has the formula PtₓM_{z}Y_{1-x-z}, and wherein:
M is selected from the group consisting of Ir, Rh, Co, Ni and combinations thereof;
Y is selected from the group consisting of Co, Ni, V, Cu, Fe, Cr, Pd, Ti, W, Al, Ag, Cu, Au and combinations thereof; and
x+z is between 0.1 and 0.9.

25. The method of claim 22, wherein the platinum alloy has the formula PtₓZ₁₋ₓ, wherein Z is selected from the group consisting of Ru, Mo, and combinations thereof, and wherein x is between 0.1 and 0.9.

26. The method of claim 16, wherein the protective layer is electrically connected to the cathode.

27. The method of claim 26, wherein catalyst particles in the protective layer are substantially electrically connected to the cathode.

28. The method of claim 27, wherein the catalyst particles and the cathode are connected via a high surface area support material.

29. The method of claim 16, wherein the protective layer has a porosity of less than 10%.

30. The method of claim 29, wherein the protective layer is substantially non-porous.

31. The method of claim 16, wherein the protective layer is an electrically connected and ionically conductive structure having a porosity of between 0% and 10%, wherein the catalyst is present in an amount between 10% and 50% vol based upon volume of the layer, and ion-exchange material is present in an amount between 50% and 80% vol based upon volume of the layer.
